(19) United States
(12) Patent Application Publication
(10) Pub. No.: US 2014/0168060 A1
(43) Pub. Date: Jun. 19, 2014

(54) WRISTWATCH AND METHOD OF LIGHTING SCREEN THEREOF

(71) Applicant: HON HAI PRECISION INDUSTRY CO., LTD., New Taipei (TW)

(72) Inventors: KUANG-YAO LIAO, New Taipei (TW); SHIANG-HUA LIN, New Taipei (TW)

(73) Assignee: HON HAI PRECISION INDUSTRY CO., LTD., New Taipei (TW)

(21) Appl. No.: 14/019,557

(22) Filed: Sep. 6, 2013

(30) Foreign Application Priority Data
Dec. 14, 2012 (TW) 101147689

(51) Int. Cl. G06F 3/01

(52) U.S. Cl. CPC G06F 3/017
USPC 345/156

(57) ABSTRACT

A wristwatch includes a screen, a backlight module to light the screen, a power source, a breakover module, a storage module, a gesture identifying module, and a processor. The breakover module connects to the power source and the backlight module and controls the supply of power from the power source to the backlight module. The storage module stores relationships between gestures and functions corresponding to the gestures. The functions include turning on the screen and turning off the screen. The gesture identifying module identifies a hand gesture of a user and determines the function of the hand gesture. The processor connects the breakover module, and controls the breakover module to break over according to the function of turning on the screen and controls the breakover module to break off according to the function of turning off the screen. A method of lighting a screen of a wristwatch is also provided.

### BACKGROUND

1. Technical Field

The present disclosure relates to a wristwatch and a method of lighting a screen of the wristwatch.

2. Description of Related Art

People wear wristwatches for conveniently knowing the time. Electronic wristwatches typically include backlight modules for illuminating the screens that display the time, and buttons for people to activate the backlight modules. Therefore when the screen needs illumination in order for a person to know the time, he/she must use his/her hand to press the button.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic top plan view of a wristwatch, according to an embodiment of the present disclosure.

FIG. 2 is a block diagram of certain components of the wristwatch of FIG. 1.

FIG. 3 is a flowchart of a method of lighting a screen of a wristwatch such as the wristwatch of FIG. 1, according to an embodiment of the present disclosure.

### DETAILED DESCRIPTION

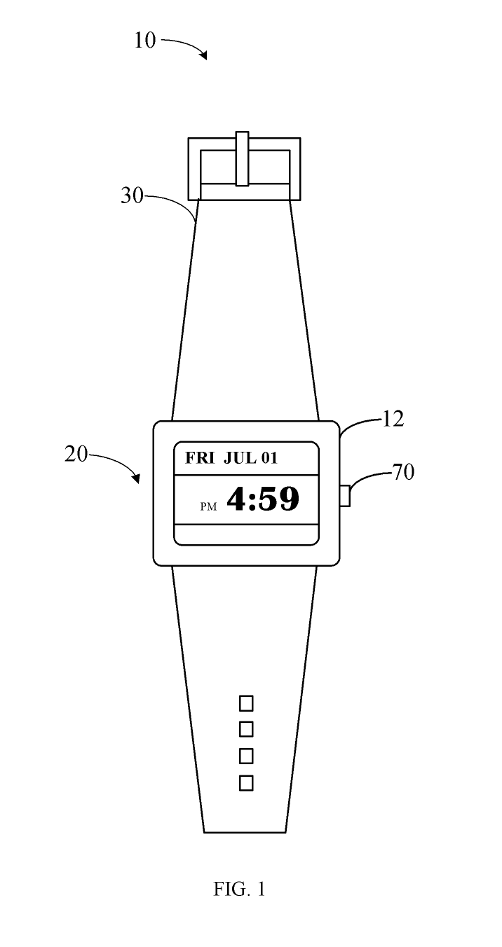

FIG. 1 shows an exemplary embodiment of a wristwatch 10. The wristwatch 10 includes a watch body 20, and a strap 30 extending from two ends of the watch body 20 so that the wristwatch 10 is suitable for being worn by a user.

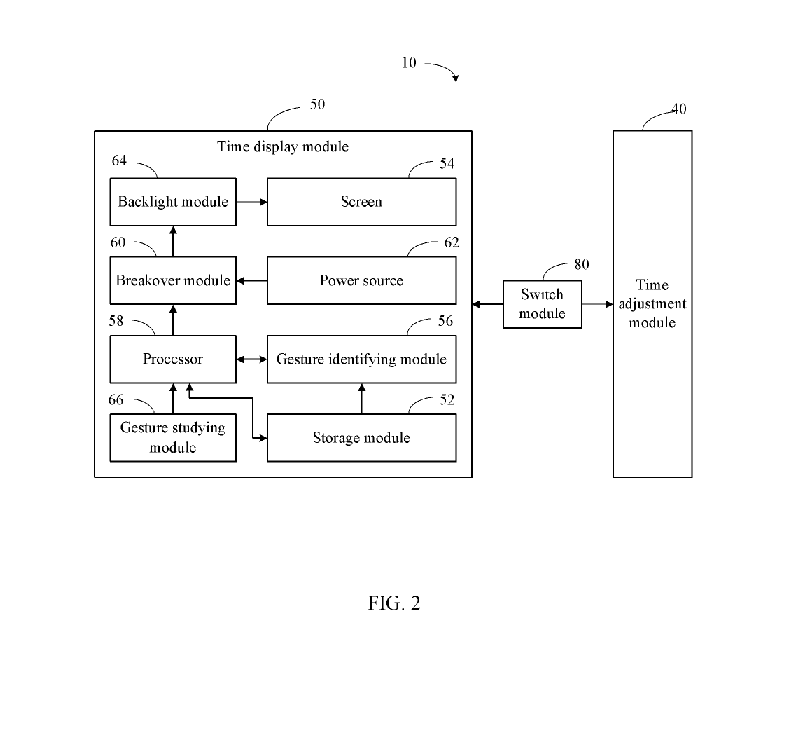

FIG. 2 shows that the wristwatch 10 includes a time adjustment module 40 for adjusting the time when the wristwatch 10 is in a time adjustment mode, a time display module 50 for displaying the time when the wristwatch 10 is in a time display mode, and a switch module 80 for switching the wristwatch 10 between the time adjustment mode and the time display mode. The switch module 80 includes a button 70 positioned on a housing 12 of the watch body 20.

The time adjustment module 40 can employ any time adjustment mechanism of a wristwatch known in the prior art. Accordingly, a detailed description of the time adjustment module 40 is omitted from this disclosure.

The time display module 50 includes a storage module 52, a screen 54, a gesture identifying module 56, a processor 58, a breakover module 60, a power source 62, a backlight module 64, and a gesture studying module 66.

The storage module 52 is configured to store relationships between gestures and functions corresponding to the gestures. Such relationships are hereinafter referred to as “gesture-function relationships.” The functions in the gesture-function relationships include a function of turning on the screen 54 and a function of turning off the screen 54. In the exemplary embodiment, the gestures in the gesture-function relationships include a raised hand gesture and a lowering of the hand gesture. The function of the turning on the screen 54 corresponds to the raised hand gesture. The function of turning off the screen 54 corresponds to the lowering of the hand gesture.

The gesture identifying module 56 is configured to identify hand gestures of the user wearing the wristwatch 10. In the exemplary embodiment, the gesture identifying module 56 is a motion sensor, and is positioned on the strap 30. In other embodiments, the gesture identifying module 56 is positioned on or in the watch body 20. The gesture identifying module 56 detects multi-dimensional vector values (e.g. of acceleration) of a gesture, such as three-dimensional vector values, to identify the gesture.

The gesture identifying module 56 further determines whether the identified gesture is stored in the storage module 52 according to the gesture-function relationships. If the identified gesture is stored in the storage module 52, the gesture identifying module 56 further determines whether the function corresponding to the identified gesture is turning on the screen 54 or turning off the screen 54, according to the gesture-function relationships. If the identified gesture is not stored in the storage module 52, the gesture studying module 66 studies the identified gesture; and if the identified gesture is repeated by the user, the gesture studying module 66 also records the number of times the identified gesture is repeated.

The processor 58 is connected to the breakover module 60. The processor 58 is configured to control the breakover module 60 to break over according to the function of turning on the screen 54, and control the breakover module 60 to break off according to the function of turning off the screen 54. The processor 58 is further configured to store the recorded gesture to the storage module 52 when the number of times of repeating the recorded gesture reaches a preset value (such as three times), and assign the function of turning on the screen 54 to the recorded gesture.

The breakover module 60 is connected with the power source 62 and the backlight module 64. The breakover module 60 is configured to control connectivity of the power source 62 such that the power source 62 supplies power to the backlight module 64 or does not supply power to the backlight module 64. Specifically, the power source 62 supplies power to the backlight module 64 when the breakover module 60 is in an electrically closed state. When the breakover module 17 is in an electrically open state, the power source 62 does not supply power to the backlight module 64.

The backlight module 64 is configured to light the screen 54 to display the time. For example, the screen 54 may need lighting when the wristwatch 10 is used in the dark.

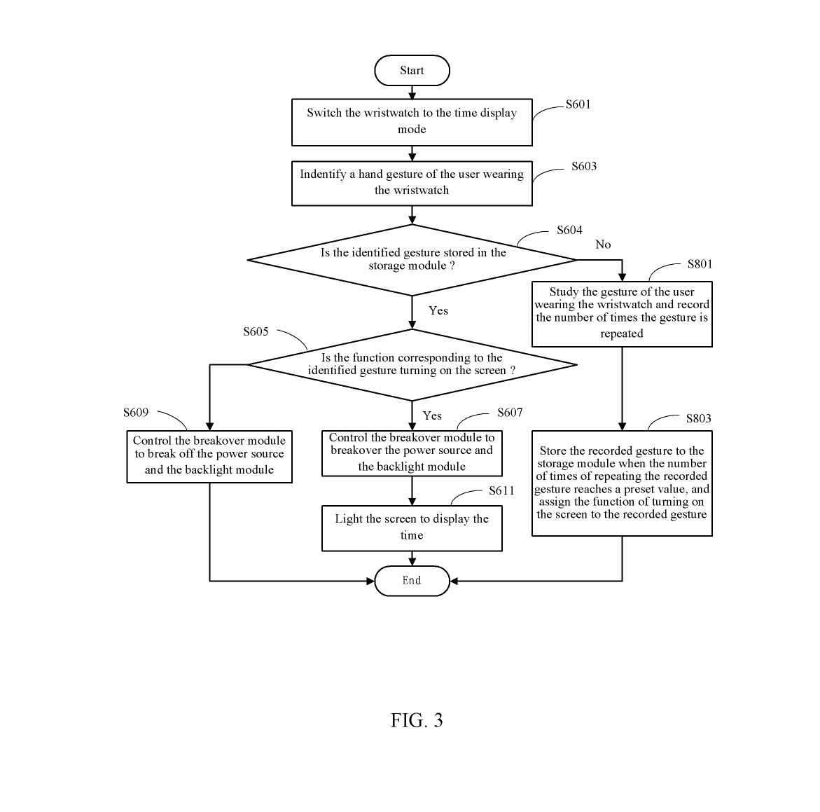

FIG. 3 shows a flowchart of lighting a screen of a wristwatch such as the wristwatch 10.

In step S601, the switch module 60 switches the wristwatch 10 to the time display mode.

In step S603, the gesture identifying module 56 identifies a hand gesture of the user wearing the wristwatch 10. In the exemplary embodiment, the gesture identifying module 56 is a motion sensor and positioned on the strap 30. The gesture identifying module 56 detects multi-dimensional vector values (e.g. of acceleration) of the gesture to identify the gesture.

In step S604, the gesture identifying module 56 determines whether the identified gesture is stored in the storage module 52 according to the gesture-function relationships. The functions in the gesture-function relationships include the function of turning on the screen 54 and the function of turning off the screen 54. In the exemplary embodiment, the gestures in the gesture-function relationships include a raised hand gesture and a lowering of the hand gesture. The function of turning on the screen 54 corresponds to the raised hand gesture. The function of turning off the screen 54 corresponds to the lowering of the hand gesture. If the identified gesture corresponding to the detected multi-dimensional vector values is stored in the storage module 52, the procedure goes to step S605; otherwise the procedure goes to step S801.

In step S605, the gesture identifying module 56 further determines that the function corresponding to the identified gesture is turning on the screen 54 or turning off the screen 54, according to the gesture-function relationships. If the gesture identifying module 56 determines that the function corresponding to the identified gesture is turning on the screen 54, the procedure goes to step S607; otherwise the procedure goes to step S609.

In step S607, the processor 58 controls the breakover module 60 to break over the power source 62 and the backlight module 64. Thus, the power source 62 supplies power to the backlight module 64.

In step S609, the processor 58 controls the breakover module 60 to break off the power source 62 and the backlight module 64. Thus, the power source 62 does not supply power to the backlight module 64.

In step S611, the backlight module 64 lights the screen 54 to display the time.

In step S801, the gesture studying module 66 studies the gesture of the hand wearing the wristwatch 10; and if the gesture is repeated by the user, the gesture studying module 66 also records the number of times the gesture is repeated.

In step S803, the processor 58 stores the recorded gesture to the storage module 52 when the number of times of repeating the recorded gesture reaches a preset value (such as three times), and assigns the function of turning on the screen 54 to the recorded gesture.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A wristwatch comprising:
a watch body;
a screen configured to display the time;
a backlight module configured to light the screen;
a power source;
a breakover module connected with the power source and the backlight module and configured to control connectivity of the power source such that the power source supplies power to the backlight module or does not supply power to the backlight module;
a storage module configured to store relationships between hand gestures of a user of the wristwatch and functions corresponding to the gestures, the functions comprising turning on the screen and turning off the screen;
a gesture identifying module configured to identify a hand gesture of a user wearing the wristwatch and determine a corresponding function of the identified gesture on condition that the identified gesture is in the stored relationships; and
a processor connected to the gesture identifying module and the breakover module and configured to control the breakover module to break over according to the function of turning on the screen, and control the breakover module to break off according to the function of turning off the screen.

2. The wristwatch as described in claim 1, further comprising at least one strap extending from two ends of the watch body and configured for being worn by a user, wherein the gesture identifying module is a motion sensor and positioned on one of the at least one strap, and the gesture identifying module is configured to detect multi-dimension vector values of the gesture to identify the gesture.

3. The wristwatch as described in claim 1, wherein the gestures of the stored relationships include a raised hand gesture and a lowering of the hand gesture, the function corresponding to the raised hand gesture is turning on the screen, and the function corresponding to the lowering of the hand gesture is turning off the screen.

4. The wristwatch as described in claim 1, further comprising a gesture studying module, wherein the gesture studying module is configured to, on condition that the identified gesture is not stored in the stored relationships, study the identified gesture and record the number of times the identified gesture is repeated by the user, and the processor is further configured to store the recorded gesture to the storage module when the number of times of repeating the recorded gesture reaches a preset value and assign the function of turning on the screen to the recorded gesture.

5. A method of lighting a screen of a wristwatch, the wristwatch comprising a power source, a backlight module configured to light the screen, and a breakover module, the method comprising:
identifying a hand gesture of a user wearing the wristwatch;
determining a corresponding function of the identified gesture according to stored relationships between hand gestures and functions corresponding to the gestures, the functions comprising turning on the screen and turning off the screen;
controlling the breakover module to break over the power source and the backlight module according to the function of turning on the screen;
controlling the breakover module to break off the power source and the backlight module according to the function of turning off the screen; and
the backlight module lighting the screen to display the time on condition that the breakover module breaks over the power source and the backlight module.

6. The method as described in claim 5, wherein the gestures include a raised hand gesture and a lowering of the hand gesture, the function of turning on the screen corresponds to the raised hand gesture, and the function of turning off the screen corresponds to the lowering of the hand gesture.

7. The method as described in claim 5, further comprising
studying the identified gesture on condition that the identified gesture is not stored in the stored relationships, and recording the number of times the identified gesture is repeated by the user; and
storing the recorded gesture when the number of times of repeating the recorded gesture reaches a preset value, and assigning the function of turning on the screen to the recorded gesture.
